(19) United States
(12) Patent Application Publication
(10) Pub. No.: US 2018/0266500 A1
(43) Pub. Date: Sep. 20, 2018

(54) FREEWHEEL DEVICE FOR A MOTOR VEHICLE

(71) Applicant: Schaeffler Technologies AG & Co. KG, Herzogenaurach (DE)

(72) Inventors: Andreas Götz, Wilhelmsdorf (DE); Ralph Schimpf, Fürth (DE)

(73) Assignee: Schaeffler Technologies AG & Co. KG, Herzogenaurach (DE)

(21) Appl. No.: 15/763,680

(22) PCT Filed: Sep. 12, 2016
(86) PCT No.: PCT/DE2016/200429

§ 371 Date: Mar. 27, 2018

(30) Foreign Application Priority Data
Sep. 28, 2015 (DE) 10 2015 218 545.1
Oct. 14, 2015 (DE) 10 2015 219 931.2

(51) Int. Cl. F16D 41/063

(52) U.S. Cl. CPC F16D 41/063

(57) ABSTRACT

A freewheel device for a motor vehicle includes an inner ring and an outer ring as well as at least one clutch disk. The at least one clutch disk is arranged radially between the inner ring and the outer ring and is formed by a plurality of segments, which are each connected to one another tangentially by an elastic element. The inner ring has, on an outer circumferential surface, a multiplicity of ramps, which interact with ramps, formed in a manner corresponding thereto, on an inner circumferential surface of the at least one clutch disk in order to allow a freewheeling function between the inner ring and the outer ring during a first rotation of the inner ring and to allow a locking function between the inner ring and the outer ring during a second rotation of the inner ring, which is opposed to the first rotation.

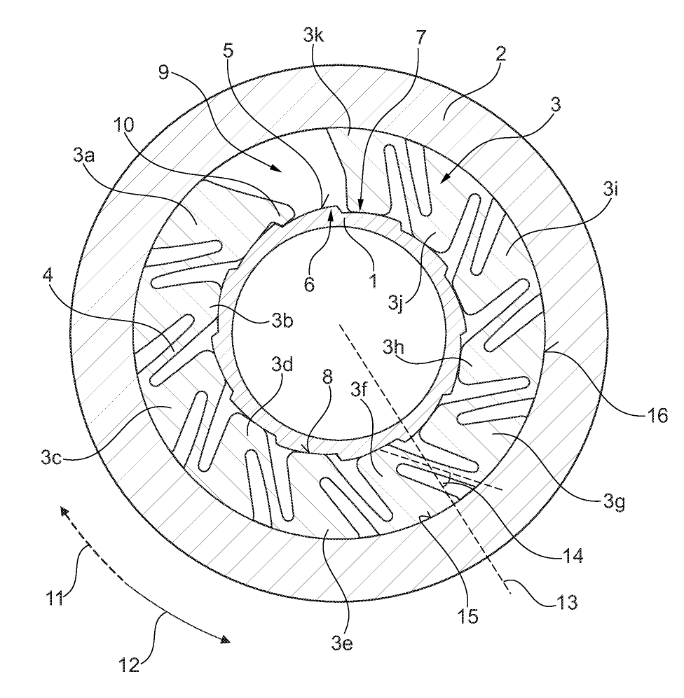

### CROSS-REFERENCE TO RELATED APPLICATIONS

This application is the United States National Phase of PCT Appln. No. PCT/DE2016/200429 filed Sep. 12, 2016, which claims priority to German Application Nos. DE102015219931.2 filed Oct. 14, 2015 and DE102015218545.1 filed Sep. 28, 2015, the entire disclosures of which are incorporated by reference herein.

### TECHNICAL FIELD

The disclosure relates to a freewheel device for a motor vehicle.

### BACKGROUND

WO 2014/011613 discloses a freewheel device for a motor vehicle. This comprises an inner ring, which has ramps on an outer circumferential surface, and an outer ring. Two clutch disks, which consist of a plurality of segments, are arranged radially between the inner ring and the outer ring. These segments are each connected to one another in the circumferential direction by an elastic element. The clutch disks furthermore have, on the inner circumferential surface thereof, ramps which are formed in a manner corresponding to the ramps on the inner ring and interact with said ramps. During a first relative movement between the clutch disks and the inner ring, a freewheeling function is enabled and, during a second relative movement between the clutch disks and the inner ring, which is opposed to the first relative movement, a locking function is enabled.

In the event of an increase in the frictional force caused by the centrifugal force and by the separation of the lubricating film, the clutch disk may jam in the freewheeling direction.

### BRIEF SUMMARY

Example aspects broadly comprise a freewheel device for a motor vehicle, including an inner ring and an outer ring as well as at least one clutch disk. The at least one clutch disk is arranged radially between the inner ring and the outer ring and is formed by a plurality of segments, which are each connected to one another tangentially by an elastic element. The inner ring has, on an outer circumferential surface, a multiplicity of ramps, which interact with ramps, formed in a manner corresponding thereto, on an inner circumferential surface of the at least one clutch disk in order to allow a freewheeling function between the inner ring and the outer ring during a first rotation of the inner ring and to allow a locking function between the inner ring and the outer ring during a second rotation of the inner ring, which is opposed to the first rotation.

In an example embodiment, the at least one clutch disk has a radial aperture, which tangentially separates a first segment of the at least one clutch disk from a final segment of the at least one clutch disk, wherein at least one ramp on the outer circumferential surface of the inner ring does not interact with any segment of the at least one clutch disk. In other words, the at least one clutch disk is not closed in the circumferential direction but has the radial aperture. There is thus one segment missing between the first and the last segment of the clutch disk. As a result, jamming of the clutch disk in the freewheeling direction, in particular, is prevented. Moreover, the absence of a segment also makes the at least one clutch disk easier to fit.

According to an example embodiment, the first segment has a hook element, which comes to rest substantially tangentially on a ramp of the inner ring in order to take along the at least one clutch disk in the freewheeling direction. The hook element is preferably formed substantially radially. Consequently, the first segment drags the remaining segments behind it in the freewheeling direction of the inner ring during the freewheeling function. The inner ring is thus connected for conjoint rotation to the clutch disk via the hook element in the freewheeling direction.

According to another example embodiment, the respective elastic element has a slope angle of 20° to 70° relative to a respective radial axis. The slope angle is preferably formed in the locking direction. The sloping design of the elastic elements has surprisingly proven favorable in terms of stress in the case of locking of the freewheel device. The sloping design of the elastic elements thus reduces the stresses in the at least one clutch disk.

The disclosure includes the technical teaching that an inner circumferential surface of the outer ring is of cylindrical design. An outer circumferential surface of the at least one clutch disk may be likewise of cylindrical design.

### BRIEF DESCRIPTION OF THE DRAWING

Further measures that improve the disclosure are explained in greater detail below together with the description of an example illustrative embodiment of the disclosure with reference to the single FIGURE.

The FIGURE shows a schematic sectional representation intended to illustrate the construction of a freewheel device according to the disclosure.

### DETAILED DESCRIPTION

According to the FIGURE, a freewheel device according to the disclosure for a motor vehicle (not shown here) has an inner ring 1 and an outer ring 2 as well as a clutch disk 3, which is arranged radially between the inner ring 1 and the outer ring 2. The clutch disk 3 consists of eleven segments 3a-3k, which are each connected to one another tangentially by an elastic element 4. The respective elastic element 4 has a slope angle 14 of about 35° relative to a respective radial axis 13.

The clutch disk 3 furthermore has a radial aperture 9, which tangentially separates a first segment 3a of the clutch disk 3 from a final segment 3k of the clutch disk 3. As a result, jamming of the clutch disk 3 in the freewheeling direction 11, in particular, is prevented.

The inner ring 1 has twelve ramps 6 on an outer circumferential surface 5. Eleven of the twelve ramps 6 on the inner ring 1 interact with a respective segment 3a-3k of the clutch disk 3. For this purpose, ramps 7, which are complementary to the ramps 6 on the inner ring 1, are formed on an inner circumferential surface 8 of the clutch disk 3. In other words, each segment 3a-3k has a respective ramp 7, which is provided for the purpose of interacting with a respective ramp 6 on the inner ring 1 in order to allow a freewheeling function between the inner ring 1 and the outer ring 2 during a first rotation of the inner ring 1 and to allow a locking function between the inner ring 1 and the outer ring 2 during a second rotation of the inner ring 1, which is opposed to the first rotation.

The first segment 3a has a hook element 10, which comes to rest substantially tangentially on a ramp 6 of the inner ring 1 in order to take along the at least one clutch disk 3 in the freewheeling direction 11. In this case, the hook element 10 is formed substantially radially inward. Thus, the freewheeling direction 11 is in the clockwise direction, while a locking direction 12 is accordingly in the counterclockwise direction. An inner circumferential surface 15 of the outer ring 2 is of cylindrical design, as is an outer circumferential surface 16 of the clutch disk 3.

During rotation of the inner ring 1 relative to the outer ring 2 in the locking direction 12, the respective ramps 6 on the inner ring 1 run up on the respective ramps 7 on the clutch disk 3, resulting in radial expansion of the clutch disk 3. This gives rise to a connection for conjoint rotation between the outer ring 2, the clutch disk 3 and the inner ring 1. In other words, the clutch disk is clamped radially between the outer ring 2 and the inner ring 1.

During rotation of the inner ring 1 relative to the outer ring 2 in the freewheeling direction 11, the respective ramps 6 on the inner ring 1 run down on the respective ramps 7 on the clutch disk 3. Furthermore, the hook element 10 on the first segment 3a comes to rest substantially tangentially on a ramp 6 of the inner ring 1 and takes the clutch disk 3 along in the freewheeling direction 11. In other words, the clutch disk 3 rotates together with the inner ring 1 in the freewheeling direction 11. There is no torque transmission between the outer ring 2 and the inner ring 1.

### LIST OF REFERENCE NUMERALS

1 inner ring
2 outer ring
3 clutch disk
3a-3k segment
4 elastic element
5 outer circumferential surface of the inner ring
6 ramps on the inner ring
7 ramps on the clutch disk
8 inner circumferential surface of the clutch disk
9 aperture
10 hook element
11 freewheeling direction
12 locking direction
13 radial axis
14 slope angle
15 inner circumferential surface of the outer ring
16 outer circumferential surface of the clutch disk

1-10. (canceled)

11. A freewheel device for a motor vehicle, comprising:
an inner ring comprising a first plurality of ramps on an outer circumferential surface;
an outer ring; and,
at least one clutch disk:
with a second plurality of ramps on an inner circumferential surface;
arranged radially between the inner ring and the outer ring;
formed by a plurality of segments, each segment in the plurality of segments connected to another segment in the plurality of segments by an elastic element; and,
including a radial aperture that tangentially separates a first segment of the plurality of segments from a final segment of the plurality of segments;
wherein:
the first plurality of ramps and the second plurality of ramps are arranged to interact with each other in order to allow a freewheeling function between the inner ring and the outer ring during a first rotation of the inner ring and to allow a locking function between the inner ring and the outer ring during a second rotation of the inner ring, which is opposite the first rotation; and,
at least one of the first plurality of ramps does not interact with any of the plurality of segments.

12. The freewheel device as claimed in claim 11, wherein the first segment of the plurality of segments has a hook element arranged to rest one of the first plurality of ramps to rotate the at least one clutch disk in a direction of the first rotation.

13. The freewheel device as claimed in claim 12, wherein the hook element is formed substantially radially.

14. The freewheel device as claimed in claim 11, wherein each elastic element has a slope angle of 20° to 70° relative to a respective radial axis.

15. The freewheel device as claimed in claim 14, wherein the slope angle is formed in a direction of the second rotation.

16. The freewheel device as claimed in claim 11, wherein the outer ring comprises a cylindrical inner circumferential surface.

17. The freewheel device as claimed in claim 11, wherein the at least one clutch disk comprises a cylindrical outer circumferential surface.

18. The freewheel device as claimed in claim 11, wherein:
the at least one clutch disk has eleven segments;
the inner ring has twelve ramps; and,
eleven of the twelve ramps on the inner ring interact with a respective segment of the at least one clutch disk.
